(19) United States
(12) Patent Application Publication
(10) Pub. No.: US 2005/0021463 A1
(43) Pub. Date: Jan. 27, 2005

(54) Product for and method of securing funding for higher education

(76) Inventor: William Miller, Santa Fo, NM (US)

Correspondence Address: LAW OFFICES OF MARK E WIEMELT, PC, 10 SOUTH LASALLE STREET, STE. 3300, CHICAGO, IL, 60603, US

(21) Appl. No.: 10/690,140

(22) Filed: Oct. 21, 2003

Related U.S. Application Data
(60) Provisional application No. 60/488,976, filed on Jul. 22, 2003.

(51) Int. Cl. G06F 17/60

(52) U.S. Cl. 705/40

(57) ABSTRACT

A product and method for financing expected future educational expenses. The method includes the basic steps of acquiring information on past educational expenses at institutions of higher learning, using this information to estimate the amount necessary to fund future educational expenses, setting up an insurance policy with a benefit sufficient to cover those expenses, disbursing the proceeds of the policy to a trust fund, and paying out the proceeds of the trust fund to the beneficiary upon admission to an institution of higher learning.

This is a non-provisional application of provisional patent application Ser. No. 60/488,976 filed 7-22-2003.

### BACKGROUND OF THE INVENTION

The present invention relates to a unique product for and method of securing funding for higher education for those who wish to structure the payment of insurance proceeds to a beneficiary who has not yet reached the age of majority and for those who wish to provide for the use of insurance proceeds for the payment of all or a portion of the expenses of higher education. The present invention is well suited to employers and other group marketers of insurance products.

Most life insurance is purchased with the needs of the surviving children as a key component of the estate plan, and most insureds identify the proper funding of their children's college or secondary education as being one of the most important considerations in determining the amount and kind of insurance to purchase. However, complicating the decision-making process is the fear that the insurance proceeds may not be used for the intended purpose. Any number of events could occur subsequent to death that would thwart the estate plan.

There remains the need to eliminate the risks associated with estate planning and to provide a process by which individuals can facilitate funding of all or a portion of their children's education with a minimum of time and expense. Currently, no product or process exists to meet this need.

### SUMMARY AND OBJECTS OF THE INVENTION

The present invention includes a product for and method of securing the financing of expected future educational expenses.

In this respect, before explaining the preferred embodiment of the present invention in detail, it is to be understood that the present invention is not limited in its application to the details set forth in the following description. The present invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other products, methods and systems for carrying out the several purposes of the present invention. It is important, therefore, that the claims be regarded as including such equivalent products and processes insofar as they do not depart from the spirit and scope of the present invention.

Further, the purpose of the abstract is to enable the U.S. Patent and Trademark Office and the public generally, and especially the practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the present invention in any way.

It is, therefore, the primary object of this invention is to secure funding of the educational expenses of the children of the insured, or any other juvenile beneficiary of a life insurance policy, through a process that directs payment of insurance proceeds to a trust fund that is managed by an insurance company or a financial institution that receives the proceeds for benefit of the named juvenile beneficiary. The proceeds of the trust are disbursed upon attendance at an institution of higher education for the purpose of paying for the expenses associated therewith or upon the juvenile beneificary attaining certain ages. A surviving spouse or other probate interest will have no opportunity to influence the payment of the insurance proceeds.

It is also an object of this invention to introduce to employers and group marketers of insurance products an innovative and novel method of providing services to their customers. Group marketing may benefit from certain economies of scale regarding premium collection and enrollment and communication activities and thus may be able to offer a lower rate.

The present invention includes the filing of an individual term life product where the death benefit is paid to a trust that is administered by an insurance company or financial institution. Upon admission to an institute of higher learning, the beneficiary will make an application to the trust to obtain some or all of the predetermined annual allowance that is available for educational needs. The child may draw upon the account each year up to the maximum allowance, with any unused portion for any year being rolled over for subsequent use. If the juvenile beneficiary does not draw upon the funds upon the attainment of certain ages for the purposes of funding higher education, the beneficiary nevertheless may draw upon the account.

The present invention includes the determination of current costs associated with typical educational needs, such as tuition, room, board and book. For example, the United States Department of Education's published Average Undergraduate College Costs, by State, which is publically available at www.ed.gov, is consulted for a determination of current costs associated with typical educational needs, such as tuition, room and board, although it will readily be understood that other methods may be employed.

The next step is to estimate the cost of these educational needs at some future date, such as by adjusting for inflation.

An individual term life product is then purchased. The death benefit is of sufficient amount to substantially cover the costs of higher education, and the payment of the death benefit is directed to a trust administered by an insurance company or a financial institution. Upon admission to an institute of higher learning, the beneficiary will make an application to the trust to obtain some or all of the predetermined annual allowance that is available for educational needs. The child may draw upon the account each year up to the maximum allowance, with any unused portion for any year being rolled over for subsequent use. If the juvenile beneficiary does not draw upon the funds upon the attainment of certain ages for the purposes of funding higher education, the beneficiary nevertheless may draw upon the account.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying descriptive matter discussing a preferred embodiment of the present invention.

There has thus been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention. Those skilled in the art will appreciate that the conception, upon which this disclosure is based, may readily be utilized as a basis for the designing of other products and methods for carrying out the several purposes of the present invention. It is important, therefore, that the invention be regarded as including such equivalent products and processes insofar as they do not depart from the spirit and scope of the present disclosure.

### DETAILED DESCRIPTION OF THE PREFERRED EMBODIMENT

While the invention may be susceptible to embodiments in different forms, there will be described in detail, the preferred embodiment with the understanding that the present disclosure is to be considered an exemplification of the principles of the invention, and is not intended to limit the claims to that which is described herein.

The invention is a method to secure funding of the educational expenses of the children of the insured, or any other juvenile beneficiary of a life insurance policy, through a process that directs payment of insurance proceeds to a trust fund that is managed by an insurance company or a financial institution that receives the proceeds for benefit of the named juvenile beneficiary. The proceeds of the trust are disbursed upon attendance at an institution of higher education for the purpose of paying for the expenses associated therewith. A surviving spouse or other probate interest will have no opportunity to influence the payment of the insurance proceeds.

The present invention includes the filing of an individual term life product where the death benefit is paid to a trust that is administered by an insurance company or financial institution. Upon admission to an institute of higher learning, the beneficiary will make an application to the trust to obtain some or all of the predetermined annual allowance that is available for educational needs. The child may draw upon the account each year up to the maximum allowance, with any unused portion for any year being rolled over for subsequent use. If the juvenile beneficiary does not draw upon the funds upon the attainment of certain ages for the purposes of funding higher education, the beneficiary nevertheless may draw upon the account.

The present invention includes the determination of current costs associated with typical educational needs, such as tuition, room, board and book. For example, the United States Department of Education's published Average Undergraduate College Costs, by State, which is publically available at www.ed.gov, is consulted for a determination of current costs associated with typical educational needs, such as tuition, room and board, although it will readily be understood that other methods may be employed.

The next step is to estimate the cost of these educational needs at some future date, such as by adjusting for inflation.

An individual term life product is then purchased. The death benefit is of sufficient amount to substantially cover the costs of higher education, and the payment of the death benefit is directed to a trust administered by an insurance company or a financial institution. Upon admission to an institute of higher learning, the beneficiary will make an application to the trust to obtain some or all of the predetermined annual allowance that is available for educational needs. The child may draw upon the account each year up to the maximum allowance, with any unused portion for any year being rolled over for subsequent use. If the juvenile beneficiary does not draw upon the funds upon the attainment of certain ages for the purposes of funding higher education, the beneficiary nevertheless may draw upon the account.

The insured selects the amount to be paid to the surviving child upon enrollment in college or other institutes of higher learning. If the juvenile beneficiary does not draw upon the funds upon the attainment of certain ages for the purposes of funding higher education, the beneficiary nevertheless may draw upon the account.

In the preferred embodiment, 12.5% of the total benefit selected by the employee at enrollment is paid out in each of the years the beneficiary reaches the age of 18, 19, 20 and 21. After four years of payment, 50% of the total benefit is paid. The remaining 50% of the total benefit is paid via a ten year annuity when the beneficiary reaches age 30. By age 39, the beneficiary receives the complete benefit payment.

For example, if the insured selects a total benefit of $200,000, then $25,000 would be paid out in each of the years the beneficiary reaches the age of 18, 19, 20 and 21, for a total of $100,000. The remaining $100,000 would be used to purchase a ten-year immediate pay annuity issued by an insurance company with an A.M. Best rating of A or better and would then be distributed to the beneficiary from age 30 to 39.

If the beneficiary dies prior to the total disbursement of the trust funds, the remaining funds go to the estate of the beneficiary.

Hence, while the invention has been described in connection with a preferred embodiment, it will be understood that it is not intended that the invention be limited to that embodiment. On the contrary, it is intended to cover all alternatives, modifications and equivalents as may be included within the spirit and scope of the invention as disclosed.

As to the manner of usage and operation of the instant invention, same should be apparent from the above disclosure, and accordingly no further discussion relevant to the manner of usage and operation of the instant invention shall be provided.

Therefore, the foregoing is considered illustrative of only the principles of the invention. Further, since numerous modifications and changes will readily occur to those skilled in the art, it is not desired to limit the invention to the exact method shown and described, and accordingly, all suitable modifications and equivalents may be resorted to, falling within the scope of the invention.

1. An insurance product that facilitates the payment of all or a portion of educational expenses at an institution of higher learning for a specified beneficiary, comprising a death benefit that is held in trust for a juvenile beneficiary until the beneficiary is admitted to an institution of higher learning, at which time the trust proceeds are disbursed for the purpose of paying for the expenses of higher education.

2. The product of claim 1, further comprising the distribution of the trust proceeds such that the beneficiary receives 12.5% of the proceeds in each of the years that the beneficiary reaches the age of 18, 19, 20, and 21, so that the beneficiary receives a total of 50% of the proceeds by age 21, and distribution of the remaining 50% of the proceeds to the beneficiary at age 30.

3. The product of claim 2, further comprising the distribution of the remaining 50% of the proceeds to the beneficiary at age 30 in the form of a ten-year immediate pay annuity issued by an insurance company with an A.M. Best rating of A or better.

4. A method for use in connection with an insurance plan to facilitates the payment of all or a portion of educational expenses at an institution of higher learning for a specified beneficiary, the method comprising the steps of:
a. acquiring information on historic costs and cost increases in educational expenses,
b. using the information to estimate the amount necessary to fund future educational expenses,
c. setting up an insurance policy with a death benefit sufficient to generate said amount, where the proceeds of the insurance policy are paid into a trust for the benefit of a juvenile beneficiary, and
d. distributing the trust proceeds to the beneficiary upon admission to an institution of higher learning for the purpose of paying for educational expenses.

5. The method as defined in claim 4, further comprising the steps of:
a. distributing the trust proceeds such that the beneficiary receives 12.5% of the proceeds in each of the years that the beneficiary reaches the age of 18, 19, 20, and 21, so that the beneficiary receives a total of 50% of the proceeds by age 21, and
b. distribution of the remaining 50% of the proceeds to the beneficiary at age 30.

6. The method as defined in claim 5, further comprising the step of:
a. distribution of the remaining 50% of the proceeds to the beneficiary at age 30 in the form of a ten-year immediate pay annuity issued by an insurance company with an A.M. Best rating of A or better.
